(19) United States
(12) Patent Application Publication
(10) Pub. No.: US 2025/0124299 A1
(43) Pub. Date: Apr. 17, 2025

(54) NOISE LEVERAGING METHOD AND COMPUTING DEVICE FOR TRAINING EFFICIENT AND ROBUST NEURAL NETWORK IN NEUROMORPHIC DEVICE

(71) Applicant: ALSEMY INC., Seoul (KR)

(72) Inventor: Chan Woo PARK, Seongnam-si (KR)

(73) Assignee: ALSEMY INC., Seoul (KR)

(21) Appl. No.: 18/917,747

(22) Filed: Oct. 16, 2024

(30) Foreign Application Priority Data
Oct. 17, 2023 (KR) 10-2023-0138694

(51) Int. Cl. G06N 3/094

(52) U.S. Cl. CPC G06N 3/094

(57) ABSTRACT

Provided is a noise leveraging method for training an efficient and robust neural network in a neuromorphic device which is performed by a processor, and a computing device. The noise leveraging method includes generating a low-rank matrix by performing low-rank approximation on a covariance matrix of a noise profile in the neuromorphic device, performing a generation operation of generating a vector of the low-rank matrix by multiplying the low-rank matrix and a random noise matrix, performing a computation operation of calculating a scalar projection of a gradient vector of a neural network on the generated vector, and performing an adjustment operation of adjusting weights of the neural network by adding the scalar projection to the weights.

### CROSS-REFERENCE TO RELATED APPLICATION

This application claims priority to and the benefit of Korean Patent Application No. 2023-0138694, filed on Oct. 17, 2023, the disclosure of which is incorporated herein by reference in its entirety.

### STATEMENT REGARDING GOVERNMENT SPONSORED RESEARCH

This present invention is supported by National R&D Program through the National Foundation of Korea (NRF) funded by Ministry of Science and ICT Research (2022M3F3A2A01076569).

### BACKGROUND

### Field of the Invention

The present invention relates to a neural network training method, and more particularly, a noise leveraging method and computing device for training a neural network which is efficient and robust to noise in a neuromorphic device.

### Discussion of Related Art

A neuromorphic device is a device that performs computations using physical artificial neurons. A neuromorphic device may be a resistive random-access memory (ReRAM or RRAM), a magnetic random-access memory (MRAM), or a phase-change random-access memory (PRAM).

Computations of an artificial neural network for executing a deep learning algorithm may be performed in a neuromorphic device.

A neuromorphic device may cause an error in vector matrix multiplications due to driver resistance, sensing resistance, sneak paths, interconnect parasitics, process variations, or the like. The error may degrade the accuracy of a neural network computation in the neuromorphic device.

Therefore, an artificial neural network model trained in a neuromorphic device requires consideration of variability specific to the device.

### RELATED ART DOCUMENT

(Patent Document 0001) Korean Patent Publication No. 10-2533908 (15 May 2023)

### SUMMARY OF THE INVENTION

The present invention is directed to providing a noise leveraging method and computing device for training an artificial neural network model in consideration of variability specific to a neuromorphic device.

According to an aspect of the present invention, there is provided a noise leveraging method for training an efficient and robust neural network in a neuromorphic device. The noise leveraging method for training an efficient and robust neural network in a neuromorphic device includes generating a low-rank matrix by performing low-rank approximation on a covariance matrix of a noise profile in the neuromorphic device, performing a generation operation of generating a vector of the low-rank matrix by multiplying the low-rank matrix and a random noise matrix, performing a computation operation of calculating a scalar projection of a gradient vector of a neural network on the generated vector, and performing an adjustment operation of adjusting weights of the neural network by adding the scalar projection to the weights.

The generating of the low-rank matrix comprises calculating an eigenvector and a diagonal matrix corresponding to rank k of the covariance matrix, and multiplying the eigenvector and the diagonal matrix to calculate the low-rank matrix.

The noise leveraging method further comprises performing a vector computation operation of calculating the gradient vector from the adjusted weights.

The generation operation, the computation operation, the adjustment operation, and the vector computation operation are repeated until a loss of the neural network converges.

The noise leveraging method further comprises after the loss of the neural network converges, averaging the gradient vector.

According to another aspect of the present invention, there is provided a computing device including a memory configured to store commands, and a processor configured to execute the commands.

The commands may be implemented to generate a low-rank matrix by performing low-rank approximation on a covariance matrix of a noise profile in a neuromorphic device, perform a generation operation of generating a vector of the low-rank matrix by multiplying the low-rank matrix and a random noise matrix, perform a computation operation of calculating a scalar projection of a gradient vector of a neural network on the generated vector, and perform an adjustment operation of adjusting weights of the neural network by adding the scalar projection to the weights.

The instructions to generate the low-rank matrix are implemented to calculate an eigenvector and a diagonal matrix corresponding to rank k of the covariance matrix; and multiply the eigenvector and the diagonal matrix to calculate the low-rank matrix.

The instructions are further implemented to perform a vector computation operation of calculating the gradient vector from the adjusted weights.

The generation operation, the computation operation, the adjustment operation, and the vector computation operation are repeated until a loss of the neural network converges.

The instructions are implemented to average the gradient vector after the loss of the neural network converges.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a computing device for performing a noise leveraging method for training an efficient and robust neural network in a neuromorphic device according to an exemplary embodiment of the present invention;

FIG. 2 is a diagram of a crossbar array implemented as a resistive random-access memory (ReRAM) according to an exemplary embodiment of the present invention;

FIG. 3 is a graph of a bivariate normal distribution;

FIG. 4 is a flowchart illustrating a noise leveraging method for training an efficient and robust neural network in a neuromorphic device according to an exemplary embodiment of the present invention;

FIG. 5A to FIG. 5C are a set of two-dimensional (2D) loss surface images according to an exemplary embodiment of the present invention;

FIG. 6A and FIG. 6B are a set of graphs of training loss and training accuracy according to an exemplary embodiment of the present invention; and

### DETAILED DESCRIPTION OF EXEMPLARY EMBODIMENTS

Specific structural and functional descriptions of embodiments according to the concept of the present invention are disclosed for illustrative purposes only. Embodiments according to the concept of the present invention may be implemented in various forms and are not limited to embodiments disclosed herein.

Embodiments according to the concept of the present invention may be variously modified and have several forms, and exemplary embodiments will be illustrated in the accompanying drawings and described in detail in this specification. However, this is not intended to limit embodiments according to the concept of the present invention to specific forms disclosed, and the scope of this specification includes all modifications, equivalents, or substitutions incorporated into the spirit and technical scope of the present invention.

Terms such as “first,” “second,” and the like may be used to describe various components, but the components are not limited by the terms. These terms are construed only for the purpose of distinguishing one component from others. For example, without departing from the scope according to the concept of the present invention, a first component may be named a second component, and similarly, a second component may be named a first component.

When a component is referred to as being “connected” or “coupled” to another component, it should be understood that the two components may be directly coupled or connected to each other, or still another component may be interposed therebetween. On the other hand, when a component is referred to as being “directly connected” or “directly coupled” to another component, it should be understood that there is no intermediate component. Other expressions describing a relationship between components, that is, “between,” “directly between,” “neighboring,” “directly neighboring,” and the like, should be similarly interpreted.

Terminology used herein is used only to describe specific embodiments rather than limiting the present invention. Singular expressions include plural expressions unless the context clearly indicates otherwise. In this specification, the terms “include,” “have,” and the like indicate the presence of described features, integers, steps, operations, components, parts, or combinations thereof and do not preclude the presence or addition of one or more other features, integers, steps, operations, components, parts, or combinations thereof.

Unless defined otherwise, all terms including technical or scientific terms used herein have the same meaning as commonly understood by those skilled in the art. Terms like those defined in a commonly used dictionary should be interpreted with meanings consistent with the meanings in the context of the related technology, and are not interpreted in an ideal or excessively formal sense unless clearly defined herein.

Hereinafter, the present invention will be described in detail by describing exemplary embodiments of the present invention with reference to the accompanying drawings.

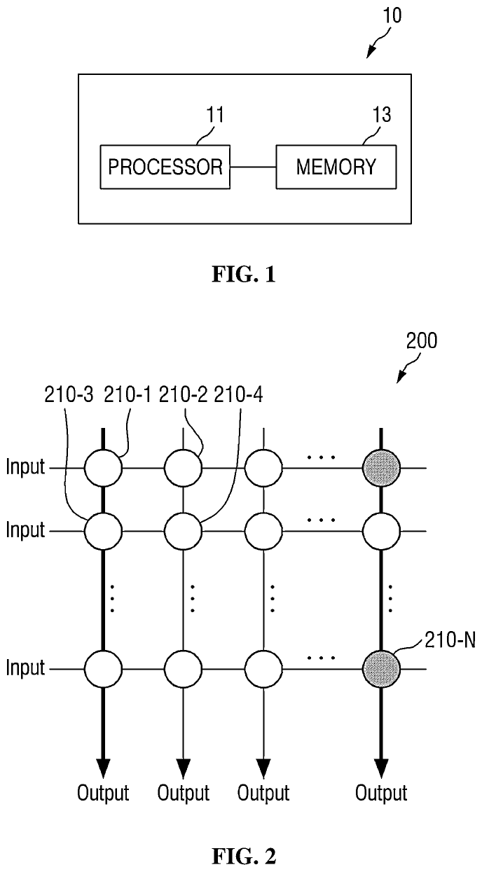

FIG. 1 is a block diagram of a computing device for performing a noise leveraging method for training an efficient and robust neural network in a neuromorphic device according to an exemplary embodiment of the present invention. Noise leveraging refers to training a neural network in consideration of noise specific to a neuromorphic device.

Referring to FIG. 1, a computing device 10 for performing a noise leveraging method for training an efficient and robust neural network in a neuromorphic device can train a neural network model that is efficient and robust to noise of the neuromorphic device by adjusting weights of the artificial neural network model in consideration of noise specific to the neuromorphic device. The computing device 10 may be an electronic device such as a server, a computer, a notebook, a tablet personal computer (PC), or a PC. The computing device 10 includes a processor 11 and a memory 13. The processor 11 executes instructions for implementing a noise leveraging method for training an efficient and robust neural network in a neuromorphic device. The memory 13 stores the instructions for implementing the noise leveraging method for training an efficient and robust neural network in a neuromorphic device. The noise leveraging method for training an efficient and robust neural network in a neuromorphic device will be described below.

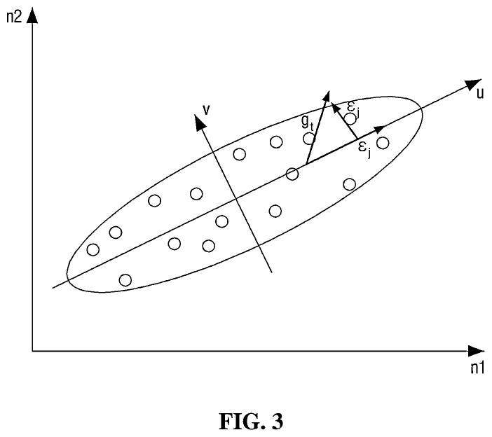

FIG. 2 is a diagram of a crossbar array implemented as a resistive random-access memory (ReRAM) according to an exemplary embodiment of the present invention.

Referring to FIG. 2, a neuromorphic device may be implemented as a crossbar array 200 including ReRAM cells 210-1 to 210-N (N is a natural number). In other words, the crossbar array 200 may be a part of the neuromorphic device. According to an embodiment, the neuromorphic device may be implemented as various memory cells, such as magnetic random-access memories (MRAMs), phase-change random-access memories (PRAMs), and the like, in addition to ReRAM cells. The crossbar array 200 may be used to perform a neural network computation. Inputs of a neural network are applied to rows of the crossbar array 200. Weights are set to resistance values of the ReRAM cells 210-1 to 210-N. Outputs of the neural network are output through columns of the crossbar array 200.

A change in the manufacturing process of the ReRAM cells 210-1 to 210-N leads to the variability among the ReRAM cells 210-1 to 210-N. Even when the same set/reset pulse signal is applied to the ReRAM cells 210-1 to 210-N with the same resistance value, the ReRAM cells 210-1 to 210-N may show different resistance states due to the variability thereamong. Properties of the ReRAM cells 210-1 to 210-N may be affected by environmental factors such as thermal instability. This causes an unregulated change in resistance state.

In addition, another factor that leads to the variability among the ReRAM cells 210-1 to 210-N is a gradual change in resistance after a program or under a constant voltage, that is, resistance drift. In the crossbar array 200, the neighboring ReRAM cells 210-1 to 210-N have similar noise characteristics due to shared local conditions and process-induced variations. This results in spatial noise correlation.

The present invention proposes a noise leveraging method for training an efficient and robust neural network in a neuromorphic device using spatial noise correlation. In other words, a neural network training method specific to a neuromorphic device employs a noise profile. A noise profile represents the variability among the ReRAM cells 210-1 to 210-N caused by a change in the manufacturing process of the crossbar array 200 including the ReRAM cells 210-1 to 210-N. In other words, a noise profile represents the variability among neuromorphic devices caused by a change in the manufacturing process of the neuromorphic devices. A neuromorphic device may be one ReRAM 210-1 or the crossbar array 200 including the ReRAM cells 210-1 to 210-N.

A noise profile represents a full-rank covariance matrix as a multivariate normal distribution. In this way, a possible correlation between noises that affect a neural network computation may be modeled. When a neural network is trained using a full-rank covariance matrix, the cost of training the neural network may remarkably increase with an increase in the number of parameters of the neural network. To address this problem, according to the present invention, low-rank approximation may be performed to reduce computational overhead related to the full-rank covariance matrix.

The present invention proposes an efficient method for a neuromorphic device (e.g., ReRAM devices) to train a neural network under a realistic noise condition.

The processor 11 performs low-rank approximation on a covariance matrix of a noise profile in a neuromorphic device to generate a low-rank matrix. In the noise profile, a full-rank covariance matrix is assumed to be a multivariate normal distribution. The multivariate normal distribution is expressed as shown in Expression 1 below.

N(μ,Σ) [Expression 1]

N is a multivariate normal distribution or a noise profile, μ is a mean vector, and Σ is a covariance matrix.

In training a neural network model using noises sampled from a multivariate normal distribution, the amount of computation excessively increases with an increase in the number of parameters of the neural network. Therefore, the processor 11 performs low-rank approximation to reduce computational overhead related to the full-rank covariance matrix. Computational complexity may be lowered from n corresponding to high dimensions to k corresponding to a low rank. n and k are natural numbers, and n is larger than k. This allows efficient noise sampling in a neural network training process.

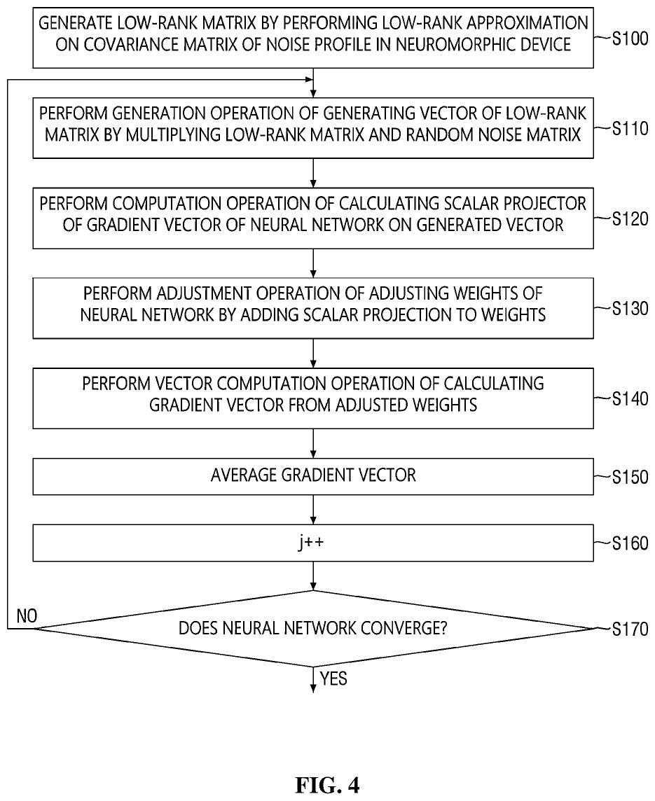

FIG. 3 is a graph of a bivariate normal distribution.

Referring to FIGS. 1 and 3, n1 and n2 are two vectors of a random variable in a covariance matrix.

A method of training an artificial neural network model in consideration of noises specific to a neuromorphic device is as follows.

The processor 11 performs low-rank approximation on a covariance matrix of a noise profile in the neuromorphic device to generate a low-rank matrix. The low-rank matrix of the covariance matrix is as shown in Expression 2 below.

$${A}_{k} = {V}_{k} {D}_{k}^{1 / 2} \qquad [ Expression 2 ]$$

Aₖ is a low-rank matrix of a covariance matrix A, Vₖ is an eigenvector, and Dₖ is a diagonal matrix. Rank-k approximation is performed on the covariance matrix A.

Specifically, the low-rank matrix is calculated as follows.

The processor 11 calculates an eigenvector and a diagonal matrix corresponding to rank k (k is a natural number) of the covariance matrix.

The processor 11 multiplies the eigenvector and the diagonal matrix to calculate the low-rank matrix as shown in Expression 2 above.

The processor 11 performs a sampling operation to sample minibatches of the neural network. This is expressed as shown in Expression 3 below.

$$β = {\{ ( {x}_{i} , {y}_{i} ) \}}_{i = 1}^{b} \qquad [ Expression 3 ]$$

β is a minibatch of a neural network, xᵢ and yᵢ are an input and an output of the neural network, and i is a turn.

The processor 11 performs a gradient computation operation of calculating a gradient vector of the neural network.

The processor 11 performs a generation operation of generating a vector of the low-rank matrix by multiplying the low-rank matrix and a random noise matrix. Assuming that the low-rank matrix is expressed as a 10,000×3 matrix, the random noise matrix may be expressed as a 3×1 matrix. Accordingly, a vector of the low-rank matrix may be expressed as a 10,000×1 matrix. The vector of the low-rank matrix is as shown in Expression 4 below.

$${η}_{j} = μ + {A}_{k} {z}_{j} \qquad [ Expression 4 ]$$

ηⱼ is a vector of the low-rank matrix, μ is a mean vector of the noise profile, Aₖ is the low-rank matrix, and zⱼ is a random noise matrix. j is a turn. ηⱼ is shown in FIG. 3.

The processor 11 performs a computation operation of calculating a scalar projection εⱼ of a gradient vector gₜ of the neural network on the generated vector ηⱼ. The computation operation of calculating the scalar projection εⱼ is as shown in Expression 5 below.

$${ϵ}_{j} = \frac{{g}_{t} \text{?} {η}_{j}}{{‖ {η}_{j} ‖}^{2}} {η}_{j} \text{?} \qquad [ Expression 5 ]$$

$$\text{?} \text{indicates text missing or illegible when filed}$$

εⱼ is a scalar projection, gₜ is a gradient vector, and ηⱼ is a generated vector. j is a turn.

The processor 11 performs an adjustment operation of adjusting weights of the neural network by adding the scalar projection to the weights. This may be expressed as shown in Expression 6.

$${W}_{t}^{j} = {W}_{t} + α {ε}_{j} \qquad [ Expression 6 ]$$

Wₜ^{j} is an adjusted weight, Wₜ is a weight for t, α is a constant, and εⱼ is a scalar projection. Adjusting a weight may be understood as leveraging noises.

The processor 11 performs a vector computation operation of calculating the gradient vector from the adjusted weights.

The processor 11 repeats the generation operation, the computation operation, the adjustment operation, and the vector computation operation until the loss of the neural network converges.

After the loss of the neural network converges, the processor 11 averages the gradient vector.

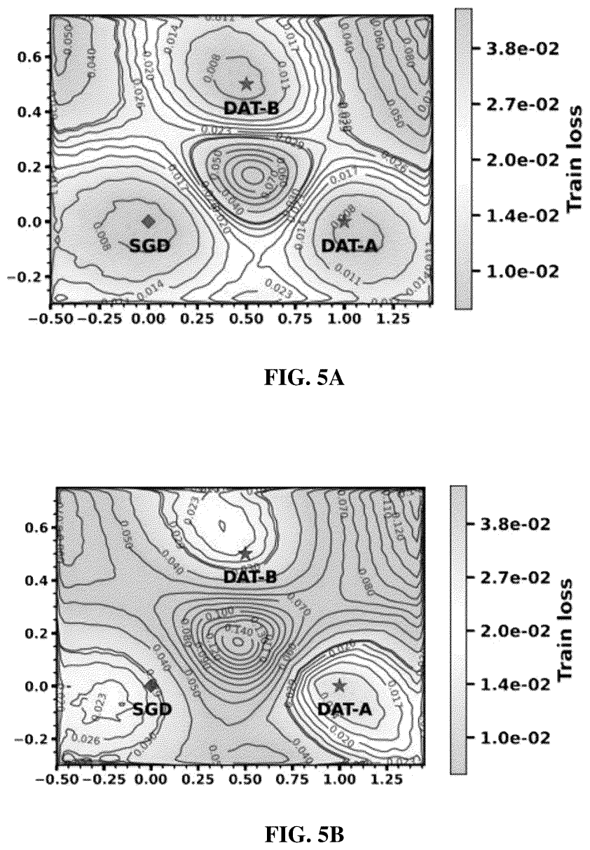

FIG. 4 is a flowchart illustrating a noise leveraging method for training an efficient and robust neural network in a neuromorphic device according to an exemplary embodiment of the present invention.

Referring to FIGS. 1 to 4, the processor 11 performs low-rank approximation on a covariance matrix of a noise profile in the neuromorphic device to generate a low-rank matrix (S100).

The processor 11 performs a generation operation of generating a vector of the low-rank matrix by multiplying the low-rank matrix and a random noise matrix (S110).

The processor 11 performs a computation operation of calculating a scalar projection of a gradient vector of a neural network on the generated vector (S120).

The processor 11 performs an adjustment operation of adjusting weights of the neural network by adding the scalar projection to the weights (S130).

The processor 11 performs a vector computation operation of calculating a gradient vector from the adjusted weights (S140).

The processor 11 performs an operation that averages gradient vectors (S150).

The processor 11 repeats the generation operation, the computation operation, the adjustment operation, and the vector computation operation until the loss of the neural network converges (S160).

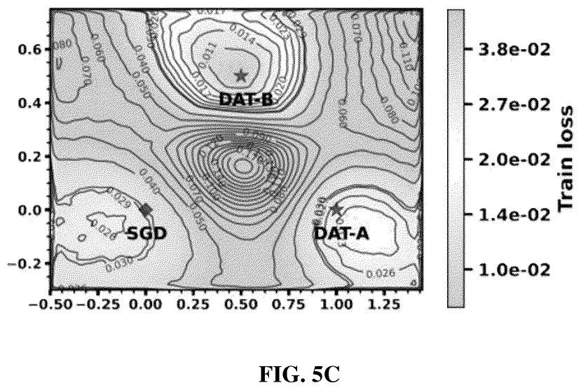

FIG. 5A and FIG. 5B are a set of two-dimensional (2D) loss surface images according to an exemplary embodiment of the present invention. FIG. 5A shows a 2D loss surface when all neuromorphic devices have no noise, FIG. 5B shows a 2D loss surface when only neuromorphic device A has a noise profile, and FIG. 5C shows a 2D loss surface when only neuromorphic device B has a noise profile.

In FIGS. 5A to 5C, “SGD” indicates a neural network model that is trained in accordance with stochastic gradient descent (SGD), and “DAT-A” indicates a neural network model that is trained using the noise profile of neuromorphic device A in accordance with device aware training (DAT). “DAT-B” indicates a neural network model that is trained using the noise profile of neuromorphic device B in accordance with DAT. A neural network model that is trained in accordance with DAT is a neural network model that is trained in consideration of a noise profile in a specific noise profile. Neuromorphic device A and neuromorphic device B are different devices.

Referring to FIGS. 5B and 5C, the neural network models that are trained in accordance with DAT maintain low loss values. This represents robustness that is improved under a specific noise condition.

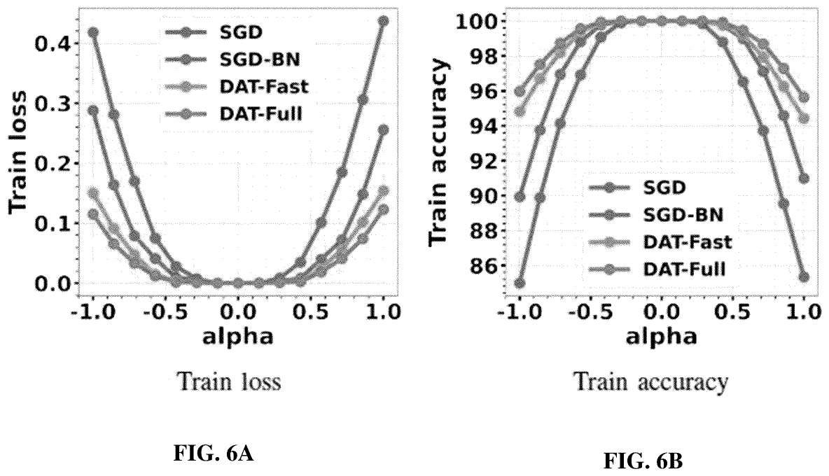

FIG. 6A and FIG. 6B are a set of graphs of training loss and training accuracy according to an exemplary embodiment of the present invention.

Referring to FIG. 6A and FIG. 6B, experimental data obtained using a 6-layer convolutional neural network (CNN) and a residual neural network (ResNet) 18 on the Canadian Institute for Advanced Research (CIFAR)-10 and CIFAR-100 datasets is as shown in a table below.

TABLE 1

| | | CIFAR-10 | | | CIFAR-100 | | |
|---|---|---|---|---|---|---|---|
| | | Train Acc. | Test Acc. | Train | Train Acc. | Test Acc. | Train |
| | | (wo/w | (wo/w | Time | (wo/w | (wo/w | Time |
| Model | Method | noise) | noise) | (min) | noise) | noise) | (min) |
| CNN | SGD | 99.9/76.2 | 87.6/74.9 | 23.4 | 99.8/70.3 | 60.8/42.5 | 23.6 |
| (6-layer) | SGD-BN | 99.9/92.5 | 90.2/83.7 | 23.2 | 99.8/92.7 | 66.4/61.3 | 23.3 |
| | DAT-Fast | 99.9/94.3 | 90.5/86.4 | 24.0 | 99.8/95.9 | 66.5/65.6 | 25.7 |
| | DAT-Full | 99.9/95.7 | 90.3/87.9 | 25.6 | 99.8/96.6 | 66.6/66.1 | 195.6 |
| ResNet18 | SGD | 100.0/95.1 | 91.8/87.3 | 47.8 | 99.9/58.2 | 72.1/43.4 | 48.0 |
| | SGD-BN | 100.0/95.9 | 95.3/89.6 | 47.3 | 99.9/94.4 | 77.6/70.8 | 47.7 |
| | DAT-Fast | 100.0/98.3 | 95.2/93.0 | 53.0 | 99.9/97.1 | 77.7/75.6 | 54.6 |
| | DAT-Full | 100.0/98.6 | 95.5/93.4 | 54.8 | 99.9/97.3 | 77.5/76.1 | 232.3 |

In Table 1 above, “wo/w noise” indicates accuracy measured when there is analog noise and accuracy measured when there is no analog noise. In Table 1 above, “SGD” indicates a neural network model trained in accordance with SGD, “SGD-BN” indicates a neural network model trained in accordance with SGD-batch normalization (BN), “DAT-Fast” indicates a neural network model to which low-rank approximation of a covariance matrix is applied, and “DAT-Full” indicates a trained neural network model to which a full covariance matrix for noise sampling is applied.

Referring to Table 1 above, the neural network model to which a covariance matrix is applied (“DAT-Fast” or “DAT-Full”) shows 10.9% and 65.4% higher performance than the neural network model trained in accordance with SGD (“SGD”) in terms of test accuracy on average for the CIFAR-10 dataset and the CIFAR-100 dataset, respectively. Degradation of SGD accuracy based on the CIFAR-100 dataset has a significant impact on the performance of a complex task including parameters with many noises. This represents that the neural network model (“DAT-Fast” or “DAT-Full”) to which a covariance matrix is applied effectively relieves performance degradation caused by noise.

Compared to “DAT-Fast,” “DAT-Full” shows slightly higher robustness to noise, but computational complexity increases due to the larger model size. In other words, “DAT-Full” requires eight times the training time of “DAT-Fast.” On the other hand, “DAT-Fast” shows almost the same robustness and generalization performance as “DAT-Full” and can significantly reduce computational requirements through low-rank approximation of a covariance matrix and minimization of a loss landscape.

FIG. 6A is a graph of training loss, and FIG. 6B is a graph of training accuracy. Specifically, FIGS. 6A and 6B show the robustness of a 6-layer CNN structure to the CIFAR-10 dataset.

Referring to FIG. 6A, a loss landscape is affected by batch normalization. This is caused by an error correction mechanism for normalizing a layer input through recentering and rescaling.

The present invention proposes DAT, that is, a method of training a neural network model applied to a specific neuromorphic device in consideration of noise specific to the neuromorphic device. Under a noise condition, the efficiency of DAT leads to an actual accuracy improvement.

According to the present invention, low-rank approximation is performed on a covariance matrix to generate a low-rank matrix, and a neural network is trained using the low-rank matrix. In this way, it is possible to balance between computational efficiency and robustness to noise.

A noise leveraging method and computing device for training an efficient and robust neural network in a neuromorphic device according to exemplary embodiments of the present invention adjust weights of an artificial neural network model in consideration of noise specific to the neuromorphic device, allowing training of the neural network model that is efficient and robust to noise of the neuromorphic device.

Although the present invention has been described above with reference to exemplary embodiments shown in the accompanying drawings, the embodiments are illustrative, and those of ordinary skill in the art should understand that various modifications and other embodiments equivalent thereto can be made from the embodiment. Therefore, the technical scope of the present invention should be determined from the technical spirit of the following claims.

What is claimed is:

1. A noise leveraging method for training an efficient and robust neural network in a neuromorphic device which is performed by a processor, the noise leveraging method comprising:
generating a low-rank matrix by performing low-rank approximation on a covariance matrix of a noise profile in the neuromorphic device;
performing a generation operation of generating a vector of the low-rank matrix by multiplying the low-rank matrix and a random noise matrix;
performing a computation operation of calculating a scalar projection of a gradient vector of a neural network on the generated vector; and
performing an adjustment operation of adjusting weights of the neural network by adding the scalar projection to the weights.

2. The noise leveraging method of claim 1, wherein the generating of the low-rank matrix comprises:
calculating an eigenvector and a diagonal matrix corresponding to rank k of the covariance matrix; and
multiplying the eigenvector and the diagonal matrix to calculate the low-rank matrix.

3. The noise leveraging method of claim 1, further comprising performing a vector computation operation of calculating the gradient vector from the adjusted weights.

4. The noise leveraging method of claim 3, wherein the generation operation, the computation operation, the adjustment operation, and the vector computation operation are repeated until a loss of the neural network converges.

5. The noise leveraging method of claim 4, further comprising, after the loss of the neural network converges, averaging the gradient vector.

6. A computing device comprising:
a memory configured to store instructions; and
a processor configured to execute the instructions,
wherein the instructions are implemented for:
generating a low-rank matrix by performing low-rank approximation on a covariance matrix of a noise profile in a neuromorphic device;
performing a generation operation of generating a vector of the low-rank matrix by multiplying the low-rank matrix and a random noise matrix;
performing a computation operation of calculating a scalar projection of a gradient vector of a neural network on the generated vector; and
performing an adjustment operation of adjusting weights of the neural network by adding the scalar projection to the weights.

7. The computing device of claim 6, wherein the instructions to generate the low-rank matrix are implemented for:
calculating an eigenvector and a diagonal matrix corresponding to rank k of the covariance matrix; and
multiplying the eigenvector and the diagonal matrix to calculate the low-rank matrix.

8. The computing device of claim 6, wherein the instructions are further implemented for performing a vector computation operation of calculating the gradient vector from the adjusted weights.

9. The computing device of claim 8, wherein the generation operation, the computation operation, the adjustment operation, and the vector computation operation are repeated until a loss of the neural network converges.

10. The computing device of claim 9, wherein the instructions are implemented for averaging the gradient vector after the loss of the neural network converges.
